(19) United States
(12) Patent Application Publication
(10) Pub. No.: US 2026/0050323 A1
(43) Pub. Date: Feb. 19, 2026

(54) User Interface (UI) Selection with Relative Head Motion as Detected by Camera

(71) Applicant: Apple Inc., Cupertino, CA (US)

(72) Inventors: David C. Mott, Los Altos, CA (US); Bosheng Zhang, Sunnyvale, CA (US); Noah D. Bedard, Los Gatos, CA (US); Robert McKeon T. Aloe, Campbell, CA (US); Kathrin Berkner Cieslicki, Los Altos, CA (US); Ethan T. Daniels, Los Gatos, CA (US); Leah M. Gum, Sunol, CA (US)

(21) Appl. No.: 19/298,519

(22) Filed: Aug. 13, 2025

Related U.S. Application Data
(60) Provisional application No. 63/682,731, filed on Aug. 13, 2024.

(51) Int. Cl. G06F 3/01; G06F 1/16; G06F 3/0485

(52) U.S. Cl. CPC G06F 3/012; G06F 1/163; G06F 3/013; G06F 3/0485

(57) ABSTRACT

Techniques are disclosed herein to perform user/device interaction tasks for electronic devices (e.g., wearable devices) with greater efficiency—and while leveraging information streams gathered by multiple types of input modalities (e.g., captured video images, as well as inertial measurement unit (IMU) data, or the like). Performance of such user/device interaction tasks are desirably able to leverage a user's natural head pointing direction, thereby enabling touchless input. According to some embodiments, the user's “relative” head motion (which has been determined to be more robust than a user's eye gaze or “absolute” head pointing direction—especially when the user is in low lighting conditions, being captured by a low-resolution camera, and/or when the area around the user's eyes is occluded), e.g., as determined from images captured by one or more integrated device cameras, may be used to determine the selection of particular UI elements on a display screen of the electronic device.

### TECHNICAL FIELD

This disclosure relates generally to the field of user/device interactions. More particularly, but not by way of limitation, it relates to techniques for user interface (UI) element selection using relative user head motion, e.g., as detected by one or more cameras or other video capture-capable devices.

### BACKGROUND

The advent of portable integrated computing devices has caused a wide proliferation of compact cameras and other video capture-capable devices. These integrated computing devices commonly take the form of smartphones, tablets, wearables (e.g., smart watches), or laptop computers, and typically include general purpose computers, cameras, sophisticated user interfaces including touch-sensitive screens, and wireless communications abilities through Wi-Fi, Bluetooth, LTE, HSDPA, New Radio (NR), and other cellular-based or wireless technologies. The wide proliferation of these integrated devices provides opportunities to use the devices'capabilities to perform tasks that would otherwise require dedicated hardware and software.

For example, portable integrated computing devices, such as smartphones, tablets, wearables, and laptops typically have one or more embedded (i.e., integrated) cameras. These cameras generally amount to lens/camera hardware modules that may be controlled through the use of a general-purpose computer using firmware and/or software (e.g., applications, or “apps”) and a user interface, including touch-screen buttons, fixed buttons, and/or touchless controls, such as gestures or voice control. The integration of cameras into these portable integrated computing devices, such as smartphones, wearables, tablets, and laptop computers, has enabled users to capture and share images and videos in ways never before possible and has allowed users to interact with devices—and for devices to understand their surroundings—in ways never before possible.

### SUMMARY

Devices, methods, and non-transitory computer-readable media (CRM) are disclosed herein to perform user interface (UI) element selection using relative user head motion, e.g., as detected by one or more cameras or other video capture-capable devices integrated into an electronic device, such as a wearable device.

For example, a method is disclosed herein, comprising: obtaining a first input image captured at a first time by a camera of an electronic device, wherein the first input image comprises a first representation of a face of a user of the electronic device; determining a first head pointing direction of the user relative to the electronic device based, at least in part, on the first representation of the face of the user of the electronic device in the first input image; and determining a first user interface (UI) element on a display of the electronic device for selection based, at least in part, on the determined first head pointing direction.

Next, the method may proceed by obtaining a second input image captured at a second (e.g., later) time by the camera of the electronic device, wherein the second input image comprises a second representation of the face of the user of the electronic device; determining a second head pointing direction of the user relative to the electronic device based, at least in part, on the second representation of the face of the user of the electronic device in the second input image; and determining that an amount of change between the first head pointing direction and the second head pointing direction exceeds a threshold value (e.g., one or more angular change thresholds).

Finally, the method may determine, e.g., in response to the amount of change between the first head pointing direction and the second head pointing exceeding the threshold value, a second UI element on the display of the electronic device for selection based, at least in part, on the determined second head pointing direction. As used herein, the “selection” of a UI element may only refer to the determination of a particular UI element to select (e.g., via visual highlighting or some other form of indication), whereas a further confirmation (e.g., via a gesture, audible command, or some other form of confirmation) from the user/wearer may need to be received at the device before actually performing the action(s) associated with the currently-selected UI element. As may be understood, such a “two-step,” i.e., selection/confirmation, process may be helpful in preventing the unwanted or inadvertent performance of particular UI element actions by a user operating an electronic device in a head/gaze motion UI control operational mode.

According to some embodiments, the electronic device comprises a wearable device, such as a smartwatch, or the like, that comprises one or more cameras capable of capturing images of the user/wearer of the electronic device.

According to other embodiments, determining the second UI element on the display of the electronic device for selection based, at least in part, on the determined second head pointing direction further comprises: dynamically enlarging an intersectional region associated with the first UI element for a temporary time interval (a process also referred to herein as adding “dynamic hysteresis”to the UI element selection process).

According to other embodiments, the method further comprises: detecting, based on an output of a first attention detection operation, that the user is paying attention to the display of the electronic device, wherein the detection of user attention precedes obtaining the first input image and determining the first head pointing direction of the user relative to the electronic device.

According to other embodiments, determining the first head pointing direction further comprises determining a user gaze direction at the first time, and wherein determining the second head pointing direction further comprises determining a user gaze direction at the second time.

According to other embodiments, determining the first head pointing direction further comprises: performing a face detection operation on the first input image to identify the first representation of the face of the user of the electronic device; and determining, based on one or more facial landmark features determined by the face detection operation, the first head pointing direction.

According to other embodiments, determining the first head pointing direction further comprises: performing a gaze detection operation on the first input image to identify a current gaze direction of the user of the electronic device; and determining, based on one or more vectors determined by the gaze detection operation, the first head pointing direction.

According to other embodiments, determining the first head pointing direction further comprises: determining the first head pointing direction based, at least in part, on applying a deep neural network (DNN) or other machine learning (ML)-based model to the first input image.

According to other embodiments, determining the first UI element further comprises at least one of: determining a UI element that is closest to the determined first head pointing direction; or determining a UI element based on settings of an application currently being displayed on the display of the electronic device.

According to other embodiments, the method further comprises: obtaining a third input image captured at a third time by the camera of the electronic device, wherein the third input image comprises a third representation of the face of the user of the electronic device; determining a third head pointing direction of the user relative to the electronic device based, at least in part, on the third representation of the face of the user of the electronic device in the third input image; determining that an amount of change between the second head pointing direction and the third head pointing direction exceeds the threshold value; and determining, in response to the amount of change between the second head pointing direction and the third head pointing exceeding the threshold value, a third UI element on the display of the electronic device for selection based, at least in part, on the determined third head pointing direction.

According to other embodiments, the threshold value is dependent, at least in part, on an axial component of an angle between the first head pointing direction and the second head pointing direction.

According to other embodiments, the method further comprises: receiving, when the second UI element on the display of the electronic device is in a selected state, a confirmation gesture from the user. According to some such embodiments, the method further comprises: performing, in response to receiving the confirmation gesture from the user, an action associated with the second UI element by an application currently being displayed on the display of the electronic device. According to some such embodiments, the action associated with the second UI element by the application currently being displayed on the display of the electronic device comprises: a UI scrolling action, wherein, e.g., the second UI element is different from the first UI element.

According to other embodiments, determining the second UI element further comprises at least one of: determining a relative difference between the first head pointing direction and the second head pointing direction; or determining the second UI element based on the second head pointing direction and independent of the first head pointing direction.

Various non-transitory computer-readable media (CRM) embodiments are also disclosed herein. Such CRM are readable by one or more processors. Instructions may be stored on the CRM for causing the one or more processors to perform any of the embodiments disclosed herein. Various electronic devices (e.g., wearable devices) are also disclosed herein, e.g., comprising memory, one or more processors, one or more image capture devices, displays and/or other electronic components (e.g., IMUs, microphones, etc.), and programmed to perform in accordance with the various method and CRM embodiments disclosed herein.

### BRIEF DESCRIPTION OF THE DRAWINGS

FIG. 1 illustrates an exemplary image of a user captured by an image capture device of a wearable electronic device, according to one or more embodiments.

FIG. 2 illustrates an example of using relative user head motion as a guide for UI element selection on a display of a wearable electronic device, according to one or more embodiments.

FIG. 3A illustrates exemplary effects of using relative user head motion as a guide for UI element selection on a display of a wearable electronic device using a rotated or an unrotated UI plane, according to one or more embodiments.

FIG. 3B illustrates exemplary effects of using relative user head motion as a cursor mover for a scrollable list UI element on a display of a wearable electronic device, according to one or more embodiments.

FIG. 4A is a flow diagram illustrating a method of using relative user head motion as a guide for UI element selection on a display of an electronic device, according to various embodiments.

FIG. 4B is a flow chart illustrating another method of using relative user head motion as a guide for UI element selection on a display of an electronic device, according to various embodiments.

FIG. 5 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

With the rise in availability of compact digital cameras in personal electronic devices has come a rise in the need for more complex processing of the data captured by such electronic devices, including the performance of user interface-related and/or environmental understanding-based tasks. In particular, such electronic devices may want to predict or determine the types of interactions that a user wishes to take with the electronic device, based on an analysis of the images in video image streams captured by a camera(s) of the electronic device. Such analysis may comprise the performance of: face detection (FD) algorithms, image understanding tasks, machine learning (ML)-based algorithms, three-dimensional (3D) scene understanding tasks, and/or 3D object understanding tasks on the captured images.

However, there remains an additional need for the ability to perform such user/device interaction tasks (and/or other types of tasks) with greater efficiency—and while leveraging information streams gathered by multiple types of input modalities (e.g., not solely captured video image stream data, but also the possibility of captured inertial measurement unit (IMU) data, individual still images, or the like).

Performance of such user/device interaction tasks are desirably able to leverage a user's natural head pointing direction, e.g., in a similar way that users currently can utilize a mouse or cursor to select particular UI elements on a device's display screen, thereby enabling touchless input. According to some such embodiments, the user's “relative” head motion (which has been determined to be more robust than a user's eye gaze or “absolute” head pointing direction—especially when the user is in low lighting conditions, captured by a low-resolution camera, and/or when the area around the user's eyes is occluded or not clear), e.g., as determined from images captured by one or more integrated device cameras, may be used to determine the selection and/or activation of particular UI elements displayed on a screen of the device (e.g., via using relative head/gaze motion to “steer” or “nudge” the currently selected UI element).

### Determining User Attention and Awareness Based on Head Pointing Direction Relative to an Electronic Device Having Image Capture Capabilities

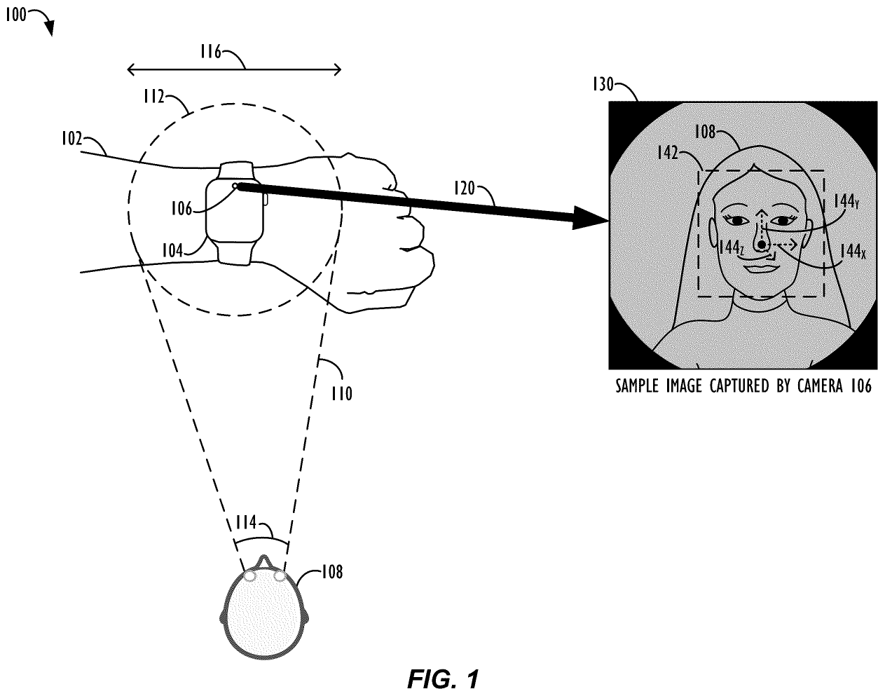

Turning first to FIG. 1, an example 100 of an image 130 of a user 108 captured by an image capture device 106 of a wearable electronic device 104 is shown, according to one or more embodiments. In the example 100 of FIG. 1, the exemplary wearable electronic device 104 is a smartwatch, which is positioned on the arm 102 of a user/wearer 108 of the electronic device.

As shown in the top-down view of the head of user 108 on the left-hand side of FIG. 1, the field of view (FOV) 110 of user 108's vision may also be represented by an angle 114. Thus, depending on the distance between user 108's head and the device 104, the region 112 in the environment in which it may be estimated or assumed that the user is currently looking at/paying attention to, may be represented by, in this example, circular region 112 having a diameter 116. As may be appreciated, the relative distances and sizes of the elements in FIG. 1 are shown merely for illustrative purposes.

Thus, if an electronic device (and, in particular, one of its displays) are within the region 112 at any given time (and, optionally, if the device 104 is not currently moving above a threshold amount), a system may make an initial coarse determination that the user is currently paying attention to the electronic device. This initial coarse determination may be helpful and/or improve overall efficiency of the system since, if a user is not even paying attention to a device at a given time, there is no need to perform further (and potentially more intensive) processing on images captured by the electronic device to attempt to determine individual UI elements that the user is currently attempting to select using their head/gaze pointing direction. As used herein, the terms head pointing direction and gaze pointing direction may refer to two different signals (e.g., it is possible for a user's head to rotate to the left, while the gaze is not changing or even rotating to right), either one of which (or both) may be used as a proxy signal for estimating a direction of a user's attention with respect to an electronic device, based on the needs and/or capabilities of a given implementation. In some embodiments, lower-powered sensors (e.g., lower power than cameras) may be used in the initial prediction of whether the user is likely about to pay attention to the display of their electronic device (e.g., an IMU for the detecting a user's arm raising, or an ALS ALS/microphone for detecting when an article of clothing is no longer covering a user's device, etc.).

In some embodiments, a UI indication or other alert may also be provided by the electronic device once user attention has been confirmed and the electronic device (and/or the app currently being displayed on the electronic device) will be entering a relative head/gaze motion UI control operational mode. In this way, the user will know that they can begin to control the device using relative head/gaze motion (and, conversely, the UI indication/alert can be removed when the relative head/gaze motion UI control operational mode is no longer active for the device).

As will be described in detail herein, according to some embodiments, in order to assist with the determination of whether the user's attention is presently on the electronic device's screen (and/or which particular UI element on the electronic device's screen the user's attention may be on), one or more images may be obtained from an image capture device 106 integrated in the electronic device 104, e.g., at a regular or irregular interval, or in response to particular condition(s) sensed at the electronic device.

In the example of FIG. 1, image capture device 106 happens to be a camera that is co-aligned (i.e., pointed in the same direction as) the normal vector of the display screen of the electronic device 104. It is to be understood that, in other embodiments, the face-related data (e.g., pointing direction vectors, and the like) extracted from the images captured by an image capture device integrated in the electronic device 104 may need to be rotated and/or translated before further analysis, i.e., so that the data more accurately reflects the environment surrounding the electronic device that is directly aligned with the surface normal of the electronic device's display.

Following arrow 120, it may be seen that exemplary image 130 represents an image captured by integrated image capture device 106 that includes a representation of the user/wearer of the electronic device 108. According to some embodiments, the image capture device 106 can be monochrome, low resolution, and/or fisheye distorted, or have other characteristics that allow the camera to perform low power, wide FOV face detection. The image capture device can be a wearable camera, a mobile device camera, or be another camera, e.g., a camera that is located elsewhere in the environment.

As illustrated in FIG. 1, according to some embodiments, heuristic-based and/or ML-based face detection algorithms may be applied to one or more of the images captured by image capture device 106. In some embodiments, the ML face detection models may preferably be lightweight enough to be able to run in a performant fashion on a wearable electronic device.

In some such embodiments, a face detection box 142 may be identified for one or more faces appearing in the captured images. In some embodiments, if multiple faces are detected in a captured image, a rule or assumption may be applied to the captured image to make a determination as to which detected face is the user/wearer of the electronic device (e.g., the largest face, the closest face to the device, the most centered face, a face that is recognized as belonging to a user of the device, etc.). As may be understood, the device will preferably only attempt to track the head/gaze movement of the actual user/wearer of the electronic device (and not other people, e.g., who may be appearing in the background of images captured by the electronic device's integrated camera(s)).

In some such embodiments, a face detection algorithm/ML-based model may also return one or more vectors that are estimated from the image data to represent the pointing direction of a face detected in the captured image data. For example, as shown in FIG. 1, the vector 144_{X} represents an estimated horizontal axial direction for the plane of the detected face 142, the vector 144_{Y} represents an estimated vertical axial direction for the plane of the detected face 142, and the vector 144_{Z} represents an estimated normal vector direction for the plane of the detected face 142. As may now be appreciated, when the estimated vector 144_{Z} is pointing in a direction that is within threshold angular range of a display of the electronic device, it may be adjudged that the user/wearer is paying attention to (i.e., looking at) the display of the electronic device. Similarly, as will be described in further detail below, when looking at the display of the electronic device, relative changes in the pointing direction of the estimated vector 144_{Z} may be used to select different UI elements on the device's display, allowing the user to navigate the device's UI in a “hands free” fashion—using only the relative change in their head/gaze pointing direction over time. In some embodiments, the face detection algorithm/ML-based model may also return a transform matrix that may be used to convert the aforementioned vectors 144 into the vector space of the image capture device, which makes the subsequent vector math more readily solvable. In other embodiments, the face detection algorithm/ML-based model may also return the relative position of the face of the user in the camera's coordinate space. In still other embodiments, the 3DoF rotation of the face may be represented in yet other ways, e.g., roll, pitch, yaw or Euler angles, etc. A quaternion can also be used to contain the same information.

### Using Relative User Head Motion as a Guide for UI Element Selection on a Display of a Wearable Electronic Device

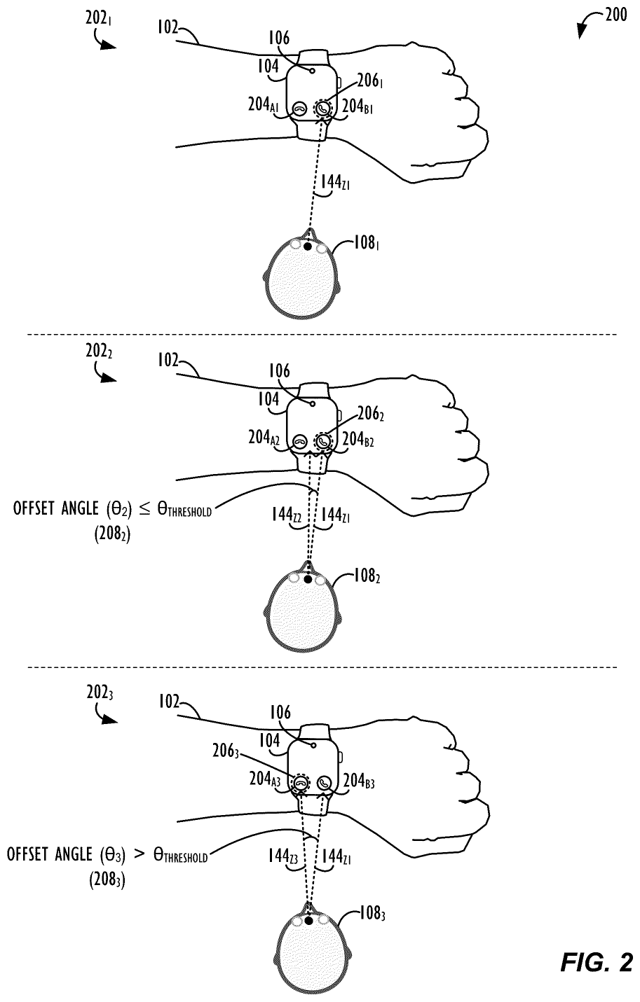

Turning now to FIG. 2, various examples 200 of using relative user head motion as a guide for UI element selection on a display of a wearable electronic device are illustrated, according to one or more embodiments. Some advantages of using relative-based head motion as a guide for UI element selection include that: 1) it doesn't require the head pointing to be exactly aligned with UI direction; 2) it doesn't require the motion to be on/land on a very small target (e.g., having the head direction ray intersect exactly within the outline of a particular small UI element); and 3) it works more robustly—even without calibration/user enrollment.

Looking first at example 202₁, the user's head 108₁ is pointing in direction 144_{Z1} that has been determined to cause the selection of UI element 204_{B1} (i.e., a call initiation UI button), i.e., rather than UI element 204_{A1} (i.e., a call hangup UI button), or any other UI element currently displayed on the display of electronic device 104. In this example, UI element 204_{B1} is highlighted with visual indicator 206₁ to indicate that it is the currently-selected UI element, based on the user's current head/gaze pointing direction (or other application/context/user-based initialization criteria). As mentioned above, either one (or both) of head pointing direction and gaze pointing direction may be used as a proxy signal for estimating a direction of a user's attention. For example, in some implementations, head pointing direction may turn out to be a more reliable and robust predictor of the current direction of a user's attention, assuming such a signal is available. If, for example, a user confirmed the current selection of UI element 204_{B1} (via gesture, audio input, or otherwise), the electronic device may perform the action of initiating a phone call to a currently displayed contact, or the like.

Looking next at example 2022, the user's head 1082 is pointing in direction 144_{Z2} that has been determined to be pointing at an offset angle, θ₂ (208₂), away from direction 144_{Z1}. In this example, the offset angle θ₂ is less than or equal to a predetermined threshold offset angle (θ_{THRESHOLD}). Because the amount of change in head/gaze pointing direction between the examples 202₁ and 202₂ is less than the threshold offset angle, the UI element 204_{B2} (i.e., the call initiation UI button) remains selected. In this example, UI element 204_{B2} remains highlighted with visual indicator 206₂ to indicate that it remains the currently-selected UI element, based on the user's current head/gaze pointing direction. If, for example, a user confirmed the current selection of UI element 204_{B2} (via gesture, audio input, or otherwise), the electronic device may perform the action of initiating a phone call from the currently displayed contact.

According to some embodiments, the predetermined threshold offset angle may be different, e.g., depending on the axial direction of the UI in which the user is attempting to move the selected UI element. For example, if a given head/gaze direction estimation algorithm had better accuracy in the x-axial direction than the y-axial direction, and implementation may use a smaller angular threshold (e.g., 5 degrees) for classifying a significant directional change in the x-axial direction and a relatively larger angular threshold (e.g., 7 degrees) for classifying a significant directional change in the y-axial direction.

Looking next at example 202₃, the user's head 108₃ is pointing in direction 144_{Z3} that has been determined to be pointing at an offset angle, θ₃ (208₃), away from direction 144_{Z1}. In this example, the offset angle θ₃ is greater than the predetermined threshold offset angle (θ_{THRESHOLD}). Because the amount of change in head/gaze pointing direction between the examples 202₁ and 202₃ is greater than the threshold offset angle, the UI element 204_{B3} (i.e., the call initiation UI button) no longer remains selected. Instead, in this example, UI element 204_{A3} becomes highlighted with visual indicator 206₃ to indicate that it is now the currently-selected UI element, based on the user's current head/gaze pointing direction. If, for example, a user confirmed the current selection of UI element 204_{A3} (via gesture, audio input, or otherwise), the electronic device may perform the action of hanging up a currently active phone call.

In the example of FIG. 2, the presently-displayed telephone call app's UI may comprise a simple 1×2 grid (i.e., 1 row with 2 columns) of selectable UI elements. Thus, the selected UI element is either the button in grid cell (1,1) (i.e., the call hangup button on the left-side) or the button in grid cell (1,2) (i.e., the call initialization button on the right side). Then, no matter where the user's initial/neutral head pointing direction is, relative head motion to the left would cause the selection of the button in grid cell (1,1) (i.e., if the button in grid cell (1,2) was currently selected), and relative head motion to the right would cause the selection of the button in grid cell (1,2) (i.e., if the button in grid cell (1,1) was currently selected). Relative head motion up or down in this example may thus have no effect on the currently-selected UI element, since this application has only a single row of selectable UI elements (unless, e.g., the user looks so far up or down that they are no longer actively pay attention to the electronic device's display screen). Other apps, of course, may have more complex, e.g., multi-dimensional with rows and columns, circular—or even freely-placed selectable UI element layouts.

As may now be appreciated, the use of “relative” motion allows the user to make simple, small turns of their head, e.g., to the left (or right), to switch between selecting either the call initiation or the call hangup UI buttons—even if their head did not start out pointing directly at one of the two UI elements. In other words, a sufficiently large movement of the head to the left relative to the current head pointing direction can cause the device to select the UI element to the left of the currently-selected UI element—even if the ray cast by the user's head/gaze pointing direction would not intersect exactly with said UI element to the left of the currently-selected UI element. If, instead, an “absolute” motion was used, the ray cast by the user's determined head/gaze direction would simply have to be intersected with the plane of the electronic device's UI (e.g., display screen), and then the closest UI element to the point of intersection could be selected.

### Applying Relative Head Motion to the UI Plane for Selection

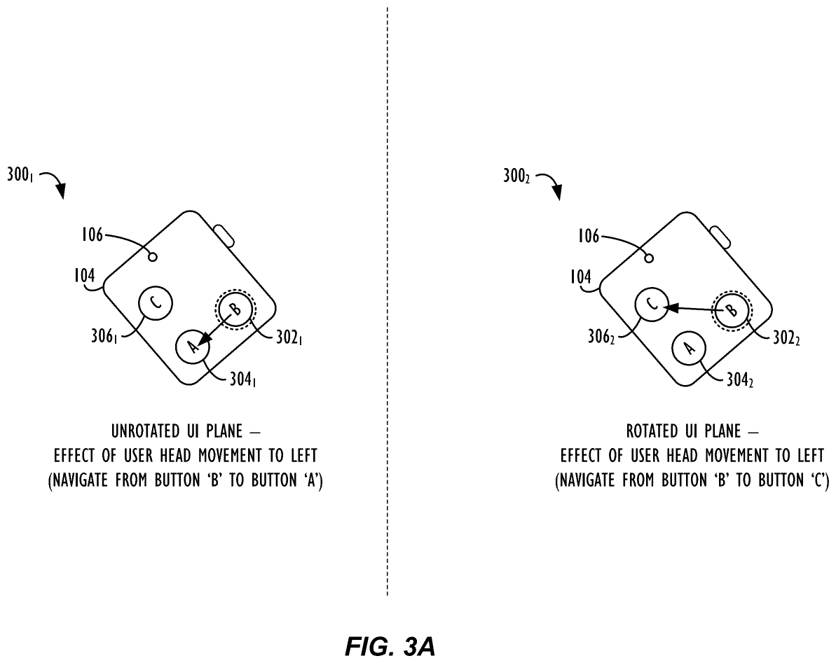

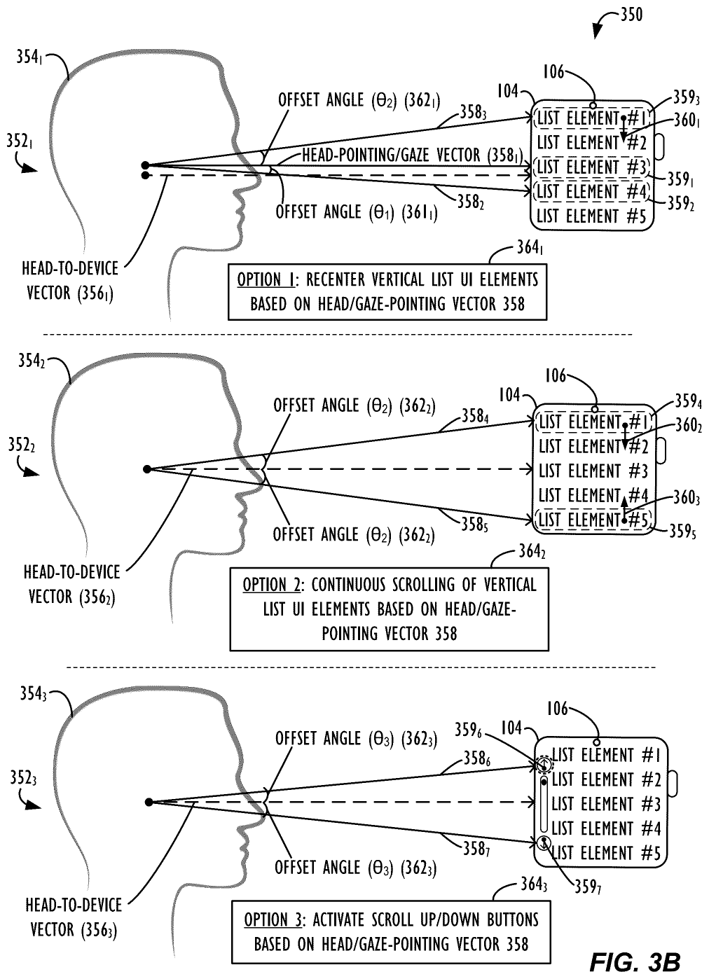

Described herein are two possible options of applying relative head motion to the UI plane of an electronic device for UI element selection that may possibly be rotated. For example, when the user moves their head to the left side, the movement may be treated as being applied to the rotated UI plane, or it may be treated as being applied to an unrotated version of the UI plane. Turning now to FIG. 3A, exemplary effects 300 of using relative user head motion as a guide for UI element selection on a display of a wearable electronic device using a rotated or an unrotated UI plane are shown, according to one or more embodiments.

Looking first at example 300₁, the effect of a user head movement to the left in the unrotated UI plane is illustrated. In other words, the head movement to the left would cause the selected UI element to move to the element directly to the left of the currently selected UI element, Button ‘B’ (302₁). In this example, that would result in the subsequent selection of UI element, Button ‘A’ (304₁), since Button ‘A’ is to the left of Button ‘B’ in the “UI space,” i.e., regardless of whether the electronic device is held right side up, upside down, tilted to the left, tilted to the right, etc.

By contrast, looking first at example 300₂, the effect of a user head movement to the left in the rotated UI plane is illustrated. In other words, the head movement to the left would cause the selected UI element to move to the element to the left of the currently selected UI element, Button ‘B’ (302₂) in “world space.” In this example, due the current rotation/tilt of the electronic device 104 to the left, that would result in the subsequent selection of UI element, Button ‘C’ (306₂), since Button ‘C’ is to the left of Button ‘B,’ as the electronic device is currently oriented in “world space.” As may be appreciated, whether the electronic device treats relative head motion as being applied to an unrotated UI plane or as being applied to the UI plane as it is currently rotated in world space is a setting that user may modify as desired.

Turning now to FIG. 3B, exemplary effects 350 of using relative user head motion as a cursor mover for a scrollable list UI element on a display of a wearable electronic device is illustrated, according to one or more embodiments.

Looking first at example 352₁, an Option #1 (364₁) for recentering vertical list UI elements based on a head/gaze pointing vector 358 is illustrated. When a user 354₁ has an initial head pointing direction (358₁) that is aligned with a head-to-device vector 356₁, an initial (e.g., currently centered) UI List Element #3 (359₁) may be selected. Then, if the user 354₁ moves their head/gaze pointing direction (358₂) by a first offset angle, θ₁ (361₁), a different (e.g., currently off-centered) UI List Element #4 (359₂) may become selected (i.e., without scrolling the vertical list of UI elements). However, if the user 354₁ moves their head/gaze pointing direction (358₃) by a second (e.g., larger) offset angle, θ₂ (362₁), another different (e.g., currently off-centered) UI List Element #1 (359₃) may become selected (which, due to the current location of the UI List Element #1 (359₃) near the edge of the display screen, may cause some scrolling (360₁) of the vertical list of UI elements, e.g., to recenter UI List Element #1 (359₃) closer to the center of the display screen.

Looking next at example 352₂, an Option #2 (364₂) for continuous scrolling of vertical list UI elements based on a head/gaze pointing vector 358 is illustrated. When a user 354₂ has an initial head pointing direction that is aligned with a head-to-device vector 356₂, then the list may not scroll. Then, if the user 354₂ moves their head/gaze pointing direction (358₄) by a first offset angle, θ₂ (362₂) in a relatively upward direction, the list may begin to scroll in a downward direction (360₂), e.g., bringing UI List Element #1 (359₄) closer to the center of the display screen, unless or until the user 354₂ realigns their head pointing direction with the head-to-device vector 356₂. By contrast, if the user 354₂ moves their head/gaze pointing direction (358₅) by the first offset angle, θ₂ (362₂) in a relatively downward direction, the list may begin to scroll in a upward direction (360₃), e.g., bringing UI List Element #5 (359₅) closer to the center of the display screen, unless or until the user 354₂ realigns their head pointing direction with the head-to-device vector 356₂.

Looking next at example 352₃, an Option #₃ (364₃) for activating scrolling of vertical list UI elements based on a head/gaze pointing vector 358 is illustrated. When a user 354₃ has an initial head pointing direction that is aligned with a head-to-device vector 356₃, then the list may not scroll. Then, if the user 354₃ moves their head/gaze pointing direction (358₆) by a first offset angle, θ₃ (362₃) that aligns with a UI element (359₆) specifically configured to cause upward scrolling of the list, the list may begin to scroll in an upward direction, unless or until the user 354₂ realigns their head pointing direction with the head-to-device vector 356₃ (or otherwise looks away from the UI element 359₆). By contrast, if the user 354₃ moves their head/gaze pointing direction (358₇) by a first offset angle, θ₃ (362₃) that aligns with a UI element (359₇) specifically configured to cause downward scrolling of the list, the list may begin to scroll in a downward direction, unless or until the user 354₃ realigns their head pointing direction with the head-to-device vector 356₃ (or otherwise looks away from the UI element 359₇).

It is to be understood that the examples 350 of FIG. 3B are merely three illustrative options for using relative head motion to control scrolling UI elements in vertical lists, and that other implementations and interpretations of relative user head/gaze motion are also possible, based on the needs of a given implementation and the types of UI element layouts used in a given app.

### Exemplary Methods of Using Relative User Head Motion as a Guide for UI Element Selection

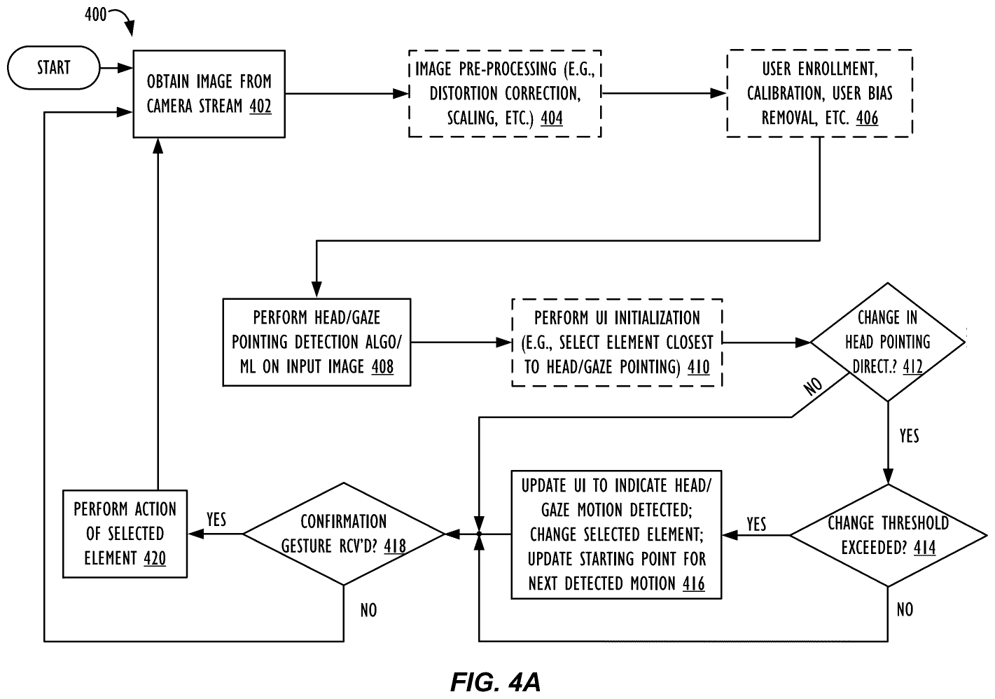

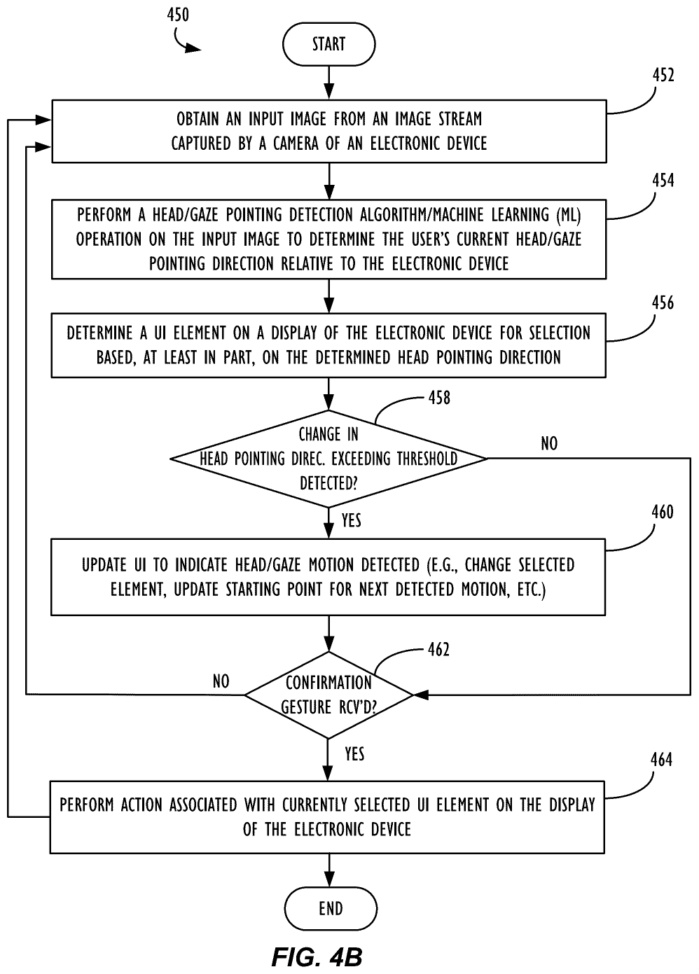

FIG. 4A is a flow diagram, illustrating a method 400 of using relative user head motion as a guide for UI element selection on a display of an electronic device, according to various embodiments. First, at Step 402, the method 400 may obtain one or more images streamed from a camera integrated in the electronic device (e.g., at a regular or irregular frame rate). Next, at Step 404, one or more image pre-processing operations may optionally be applied to the images obtained at Step 402, e.g., image distortion correction, scaling, etc., so as to place the obtained images in a form where the necessary information (e.g., face location, size, etc.) is most likely to be able to be gleaned from the obtained images using the preferred face detection algorithms or models.

Next, at Step 406, the method 400 may optionally perform one or more other operations to prepare the obtained images for further analysis. For example, user enrollment and/or calibration operations may be performed to determine any preferences/characteristics of the user presently using the electronic device, address any user-specific variations (e.g., by comparing the user's perceived head/gaze pointing directions with ground truth/ML algorithm predictions and to identify any user-specific differences), and save any determined user-specific parameters related to head/gaze pointing direction for later use. In some embodiments, the electronic device may also learn and/or store different “neutral,” i.e., centered, head pointing directions (i.e., the direction against which other relative motion may be calculated) for a given user, e.g., based on different device positions and orientations.

In some embodiments, a positional sensor, such as an inertial measurement unit (IMU), integrated within the electronic device may also be used to perform various tasks related to the user enrollment and/or calibration operations. For example, an IMU may be used to: 1) define an initialization moment of a user's interaction with the device (e.g., determining whether the device has stopped moving while the user is paying attention to the device); 2) determine a neutral direction against which relative motion is calculated (e.g., the direction at the moment when the initialization is detected); and/or 3) estimate motion and adjust thresholds (e.g., to use bigger or smaller thresholds for detecting a significant motion).

Next, at Step 408, the method 400 may perform a desired head/gaze pointing detection algorithm (e.g., leveraging image analysis, face heuristics, an ML-based model, etc.) to determine an initial head/gaze pointing direction with respect to a display of the electronic device.

Next, at Step 410, the method 400 may optionally perform a UI initialization operation, e.g., wherein the UI element that is currently being displayed on a display of the electronic device and that is the closest to the ray cast in the head pointing direction determined at Step 408 is initially selected for activation. In other embodiments, the choice of an initially selected UI element may instead be based on other factors, such as a default UI element specified by an app developer, a preferred initial UI element that is “learned” by the app over time and usage by the user, and/or a contextually-based initialization decision (e.g., if a user is in a meeting, then an incoming phone call UI screen may default to initially selecting the call hangup UI element, rather than the call answer UI element). In some embodiments, the selection of a UI element may involve highlighting, outlining, temporarily enlarging, etc., the UI element, so as to indicate what UI element would be activated by the electronic device in response to the user confirming the initial UI selection. In other embodiments, a system may instead automatically activate a UI element upon its selection by head/gaze pointing direction, i.e., without awaiting confirmation from the user that the correct UI element has been selected.

Next, at Step 412, the method 400 may determine if there has been a change in the user's head/gaze pointing direction from a previous pointing direction (e.g., in response to visual/audio feedback received from the device and/or simply the user's choice to move or change their head pointing direction, such as to look away from the electronic device). If, at Step 412, a change in the user's head/gaze pointing direction is detected from a previous pointing direction (i.e., “YES” at Step 412), the method 400 may proceed to Step 414 to evaluate whether the change has exceeded a threshed (e.g., in terms of a number of degrees in change of the head/gaze pointing direction ray, or other desired metric) indicating that the change in direction is significant enough to take action based upon. If the threshold has not been exceeded (i.e., “NO” at Step 414), the method 400 may proceed directly to Step 418. As may be understood, in some embodiments, a threshold may be employed to remove or reduce noise or fluctuations in the input signal, thereby preventing the selected UI element from changing too rapidly and/or when the user does not actually intend to change the currently selected UI element. As may also be understood, if, at Step 412, there is no change in the user's head/gaze pointing direction detected from the previous direction at all (i.e., “NO” at Step 412), the method 400 may also proceed directly to Step 418.

In some implementations, a “dynamic dragging” operation may be employed at the electronic device via user relative head/gaze motion. For example, if the user is at the limit of their range of the motion (e.g., their head is turned as far as possible to the left), the user can “drag” the threshold comparison point to the left a bit farther, e.g., so they don't have to swing their head all the way back to the right to later select a UI element that is to the right of the currently selected UI element.

If, instead, the threshold has been exceeded (i.e., “YES” at Step 414), the method 400 may proceed to Step 416, wherein the UI on the electronic device may update to indicate the change in head/gaze pointing direction detected. This may also include changing/updating the currently selected UI element (i.e., based on the newly detected head/gaze pointing direction) and updating the starting point for next detected user head/gaze motion.

According to some embodiments, determining the updated UI element on the display of the electronic device for selection may involve applying a so called “dynamic hysteresis” (or “stickiness”) to the movement of the UI selection. In one example, applying dynamic hysteresis may involve dynamically enlarging a change threshold and/or an intersectional region associated with the first UI element for a temporary time interval, i.e., so as to avoid potential accidental overshoot in the UI element selection. As used herein, the “intersectional region” associated with a UI element refers to the region on the display taken up by the UI element that, if the head pointing vector intersects with, causes the system to select that UI element.

For example, without dynamic hysteresis, a user moving their head/gaze pointing direction a number of degrees to the left might otherwise cause the currently-selected UI element to move two or three UI elements to the left of the currently-selected UI element on the display—even though the user was only attempting to move a single UI element to the left (e.g., assuming a 2×3 or 3×3 grid of selectable UI elements, such as buttons, are being displayed on the device's UI at the time). By dynamically (i.e., temporarily) adding hysteresis (e.g., for a time period of 0.3 s to 0.5 s), the system creates an artificial barrier, so that the user has to make slightly extra head/gaze motion to actually move the currently-selected UI element directly across multiple UI elements.

By contrast, static hysteresis may involve applying such an artificial barrier to the movement between UI elements at all times. Static hysteresis may be more appropriate in a system that employs “absolute” head/gaze motion detection to control UI element selection. However, when employing “relative” head/gaze motion detection to control UI element selection and provide real-time visual feedback to a user, the user will simply keep moving their head/gaze in the desired direction until the desired UI selection change is made, and the head/gaze pointing direction detection algorithm will automatically reset the starting point for the user's next head/gaze motion (e.g., back to the user's preferred “neutral” pointing direction). Thus, static hysteresis would not be needed in such a relative head motion control scheme.

After the update to the currently-selected UI element is made (and the starting point for the next detected motion has been reset), the method 400 may proceed to Step 418.

At Step 418, the method 400 may determine whether a confirmation gesture has been received from the user. In this context, the confirmation gesture confirms whether or not the user wants to activate the currently selected UI element (e.g., clicking a currently selected button, moving a currently selected cursor, typing a currently selected letter on a keyboard or, opening a currently selected file or attachment, etc.). For example, the confirmation gesture may be a hand gesture, a finger gesture, a gesture performed with the user's face or head (e.g., the user moving their head closer (or farther) from the display of the electronic device to indicate a confirmation or a rejection of a currently-selected UI element), an audible command (e.g., a user saying “OK”when a UI element is selected), etc.

If, at Step 418, a confirmation gesture is received from the user (i.e., “YES” at Step 418), the method 400 may proceed to Step 420 to perform the action of the selected UI element and then return to Step 402 to continue to obtain new images from the camera stream and continue to track the user's head/gaze pointing direction. If, instead, at Step 418, a confirmation gesture is not received from the user (i.e., “NO” at Step 418), the method 400 may return directly to Step 402 to continue to obtain new images from the camera stream and continue to track the user's head/gaze pointing direction.

Turning now to FIG. 4B, a flow chart is shown, illustrating another method 450 of using relative user head motion as a guide for UI element selection on a display of an electronic device, according to various embodiments according to various embodiments. First, at Step 452, the method 450 may obtain an input image from an image stream captured by a camera of an electronic device. Next, at Step 454, the method 450 may perform a head/gaze pointing detection algorithm/machine learning (ML) operation on the input image to determine the user's current head/gaze pointing direction relative to the electronic device. By determining the head/gaze pointing direction ray relative to the electronic device, users may be able to user their limited range of arm and head motion to adjust their arm or head independently to find a relative position and orientation that lets them interact with the device in a natural and comfortable way. Next, at Step 456, the method 450 may determine a UI element on a display of the electronic device for selection based, at least in part, on the determined head pointing direction (and, possibly, further based on a current pose of the electronic device in 3D space, e.g., as determined from IMU readings).

Next, at Step 458, the method 450 may determine whether a change in the head/gaze pointing direction determined at Step 454 as compared to a head/gaze pointing direction at an earlier point in time (e.g., 1 second earlier, 10 captured image frames earlier, the last time a face was successfully detected, etc.) exceeds a predetermined change threshold(s). If the determined change exceeds the change threshold (i.e., “YES” at Step 458), the method 450 may proceed to Step 460. If, instead, the determined change does not exceed the change threshold (i.e., “NO” at Step 458), the method 450 may proceed directly to Step 462.

At Step 460, the method 450 may update the device's UI to indicate the change in head/gaze pointing direction detected at Step 458 (e.g., change the currently selected/highlighted UI element, update the starting point direction for the next detected head/gaze motion, etc.).

At Step 462, the method 450 may determine whether a user confirmation gesture has been received. As described above, the confirmation gesture confirms whether or not the user wants to activate the currently selected UI element. If no confirmation gesture is received (i.e., “NO” at Step 462), the process may simply return to Step 452 to await further images to be obtained from the image stream captured by the camera(s) of the electronic device. If, instead, a confirmation gesture is received (i.e., “YES” at Step 462), the process may proceed to Step 464 to perform the action(s) associated with currently selected UI element on the display of the electronic device. Finally, the process may return to Step 452 to await further images to be obtained from the image stream captured by the camera(s) of the electronic device (or it may terminate, e.g., if there is no longer a need or desire to monitor user head/gaze direction changes).

The various methods described herein, e.g., with reference to FIG. 4A-4B, may be performed by an electronic device, e.g., via being initiated by an application (or “App”) executing on the device and/or the device's native operating system (OS). For example, an App executing on the device could initiate or implement all of the steps in a method, or at least a portion of the steps in the method, while making calls to the device's OS to perform other steps in the method. Similarly, a device's OS can receive API calls from an App or elsewhere and process/perform the calls to cause the method to be performed by the device(s). In some implementations, one or more of the processing steps may also be performed by a device that is remote to the electronic device, e.g., on a smartphone, laptop or other electronic device associated with the user, and/or on a server device accessible to the electronic device via a network connection (which server device may, e.g., have greater processing capacity than a wearable electronic device).

### Exemplary Electronic Computing Devices

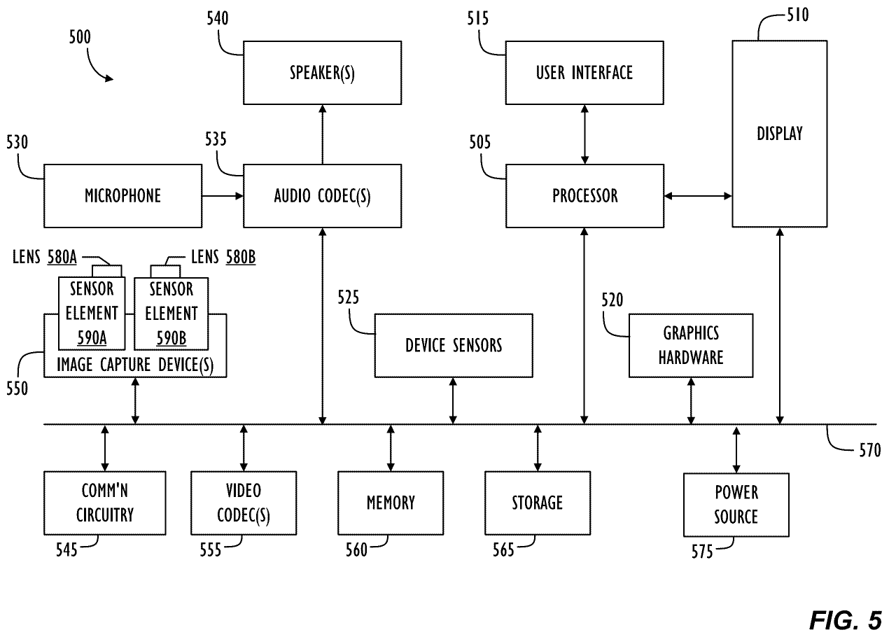

Referring now to FIG. 5, a simplified functional block diagram of illustrative programmable electronic computing device 500 is shown according to one embodiment. Electronic device 500 could be, for example, a mobile telephone, personal media device, portable camera, or a tablet, notebook or desktop computer system. As shown, electronic device 500 may include processor 505, display 510, user interface 515, graphics hardware 520, device sensors 525 (e.g., proximity sensor/ambient light sensor, accelerometer, inertial measurement unit, and/or gyroscope), microphone 530, audio codec(s) 535, speaker(s) 540, communications circuitry 545, image capture device 550, which may, e.g., comprise multiple camera units/optical image sensors having different characteristics or abilities (e.g., Still Image Stabilization (SIS), HDR, OIS systems, optical zoom, digital zoom, etc.), video codec(s) 555, memory 560, storage 565, and communications bus 570.

Processor 505 may execute instructions necessary to carry out or control the operation of many functions performed by electronic device 500 (e.g., such as the generation, processing, and/or streaming of images and video data in accordance with the various embodiments described herein). Processor 505 may, for instance, drive display 510 and receive user input from user interface 515. User interface 515 can take a variety of forms, such as a button, keypad, dial, a click wheel, keyboard, display screen and/or a touch screen. User interface 515 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 510 may display a video stream as it is captured while processor 505 and/or graphics hardware 520 and/or image capture circuitry contemporaneously generate and store the video stream in memory 560 and/or storage 565. Processor 505 may be a system-on-chip (SOC) such as those found in mobile devices and include one or more dedicated graphics processing units (GPUs). Processor 505 may be based on reduced instruction-set computer (RISC) or complex instruction-set computer (CISC) architectures or any other suitable architecture and may include one or more processing cores. Graphics hardware 520 may be special purpose computational hardware for processing graphics and/or assisting processor 505 perform computational tasks. In one embodiment, graphics hardware 520 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device 550 may comprise one or more camera units configured to capture images, e.g., images which may be processed to generate cropped, augmented, and/or distortion-corrected versions of said captured images, e.g., in accordance with this disclosure. Image capture device(s) 550 may include two (or more) lens assemblies 580A and 580B, where each lens assembly may have a separate focal length. For example, lens assembly 580A may have a shorter focal length relative to the focal length of lens assembly 580B. Each lens assembly may have a separate associated sensor element, e.g., sensor elements 590A/590B. Alternatively, two or more lens assemblies may share a common sensor element. Image capture device(s) 550 may capture still and/or video images. Output from image capture device 550 may be processed, at least in part, by video codec(s) 555 and/or processor 505 and/or graphics hardware 520, and/or a dedicated image processing unit or image signal processor incorporated within image capture device 550. Images so captured may be stored in memory 560 and/or storage 565.

Memory 560 may include one or more different types of media used by processor 505, graphics hardware 520, and image capture device 550 to perform device functions. For example, memory 560 may include memory cache, read-only memory (ROM), and/or random access memory (RAM). Storage 565 may store media (e.g., audio, image and video files), computer program instructions or software, preference information, device profile information, and any other suitable data. Storage 565 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 560 and storage 565 may be used to retain computer program instructions or code organized into one or more modules and written in any desired computer programming language. When executed by, for example, processor 505, such computer program code may implement one or more of the methods or processes described herein. Power source 575 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 500.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A method comprising:
obtaining a first input image captured at a first time by a camera of an electronic device, wherein the first input image comprises a first representation of a face of a user of the electronic device;
determining a first head pointing direction of the user relative to the electronic device based, at least in part, on the first representation of the face of the user of the electronic device in the first input image;
determining a first user interface (UI) element on a display of the electronic device for selection based, at least in part, on the determined first head pointing direction;
obtaining a second input image captured at a second time by the camera of the electronic device, wherein the second input image comprises a second representation of the face of the user of the electronic device;
determining a second head pointing direction of the user relative to the electronic device based, at least in part, on the second representation of the face of the user of the electronic device in the second input image;
determining that an amount of change between the first head pointing direction and the second head pointing direction exceeds a threshold value; and
determining, in response to the amount of change between the first head pointing direction and the second head pointing exceeding the threshold value, a second UI element on the display of the electronic device for selection based, at least in part, on the determined second head pointing direction.

2. The method of claim 1, wherein the electronic device comprises a wearable device.

3. The method of claim 1, wherein determining the second UI element on the display of the electronic device for selection based, at least in part, on the determined second head pointing direction further comprises:
dynamically enlarging an intersectional region associated with the first UI element for a temporary time interval.

4. The method of claim 1, further comprising:
detecting, based on an output of a first attention detection operation, that the user is paying attention to the display of the electronic device,
wherein the detection of user attention precedes obtaining the first input image and determining the first head pointing direction of the user relative to the electronic device.

5. The method of claim 1, wherein determining the first head pointing direction further comprises determining a user gaze direction at the first time, and wherein determining the second head pointing direction further comprises determining a user gaze direction at the second time.

6. The method of claim 1, wherein determining the first head pointing direction further comprises:
performing a face detection operation on the first input image to identify the first representation of the face of the user of the electronic device; and
determining, based on one or more facial landmark features determined by the face detection operation, the first head pointing direction.

7. The method of claim 1, wherein determining the first head pointing direction further comprises:
performing a gaze detection operation on the first input image to identify a current gaze direction of the user of the electronic device; and
determining, based on one or more vectors determined by the gaze detection operation, the first head pointing direction.

8. The method of claim 1, wherein determining the first head pointing direction further comprises:
determining the first head pointing direction based, at least in part, on applying a deep neural network (DNN) to the first input image.

9. The method of claim 1, wherein determining the first UI element further comprises at least one of:
determining a UI element that is closest to the determined first head pointing direction; or
determining a UI element based on settings of an application currently being displayed on the display of the electronic device.

10. The method of claim 1, further comprising:
obtaining a third input image captured at a third time by the camera of the electronic device, wherein the third input image comprises a third representation of the face of the user of the electronic device;
determining a third head pointing direction of the user relative to the electronic device based, at least in part, on the third representation of the face of the user of the electronic device in the third input image;
determining that an amount of change between the second head pointing direction and the third head pointing direction exceeds the threshold value; and
determining, in response to the amount of change between the second head pointing direction and the third head pointing exceeding the threshold value, a third UI element on the display of the electronic device for selection based, at least in part, on the determined third head pointing direction.

11. The method of claim 1, wherein the threshold value is dependent, at least in part, on an axial component of an angle between the first head pointing direction and the second head pointing direction.

12. The method of claim 1, further comprising:
receiving, when the second UI element on the display of the electronic device is in a selected state, a confirmation gesture from the user.

13. The method of claim 12, further comprising:
performing, in response to receiving the confirmation gesture from the user, an action associated with the second UI element by an application currently being displayed on the display of the electronic device.

14. The method of claim 13, wherein the action associated with the second UI element by the application currently being displayed on the display of the electronic device comprises: a UI scrolling action.

15. The method of claim 14, wherein the second UI element is different from the first UI element.

16. The method of claim 1, wherein determining the second UI element further comprises at least one of:
determining a relative difference between the first head pointing direction and the second head pointing direction; or
determining the second UI element based on the second head pointing direction and independent of the first head pointing direction.

17. A non-transitory computer readable medium comprising computer readable code executable by one or more processors to:
obtain a first input image captured at a first time by a camera of an electronic device, wherein the first input image comprises a first representation of a face of a user of the electronic device;
determine a first head pointing direction of the user relative to the electronic device based, at least in part, on the first representation of the face of the user of the electronic device in the first input image;
determine a first user interface (UI) element on a display of the electronic device for selection based, at least in part, on the determined first head pointing direction;
obtain a second input image captured at a second time by the camera of the electronic device, wherein the second input image comprises a second representation of the face of the user of the electronic device;
determine a second head pointing direction of the user relative to the electronic device based, at least in part, on the second representation of the face of the user of the electronic device in the second input image;
determine that an amount of change between the first head pointing direction and the second head pointing direction exceeds a threshold value; and
determine, in response to the amount of change between the first head pointing direction and the second head pointing exceeding the threshold value, a second UI element on the display of the electronic device for selection based, at least in part, on the determined second head pointing direction.

18. The non-transitory computer readable medium of claim 17, wherein the computer readable code is further executable by one or more processors to:
determine that an amount of change between the first head pointing direction and the second head pointing direction does not exceed the threshold value; and
determine, in response to the amount of change between the first head pointing direction and the second head pointing not exceeding the threshold value, to maintain the selection of the first UI element on the display of the electronic device.

19. The non-transitory computer readable medium of claim 18, wherein the computer readable code is further executable by one or more processors to:
receive, when the second UI element on the display of the electronic device is in a selected state, a confirmation gesture from the user; and
perform, in response to receiving the confirmation gesture from the user, an action associated with the second UI element by an application currently being displayed on the display of the electronic device.

20. A wearable electronic device comprising:
one or more processors;
a display;
a camera; and
one or more computer readable media comprising computer readable code executable by the one or more processors to:
obtain a first input image captured at a first time by the camera, wherein the first input image comprises a first representation of a face of a user of the wearable electronic device;
determine a first head pointing direction of the user relative to the display of the wearable electronic device based, at least in part, on the first representation of the face of the user of the wearable electronic device in the first input image;
determine a first user interface (UI) element on the display for selection based, at least in part, on the determined first head pointing direction;
obtain a second input image captured at a second time by the camera, wherein the second input image comprises a second representation of the head of the user of the wearable electronic device;
determine a second head pointing direction of the user relative to the display of the wearable electronic device based, at least in part, on the second representation of the face of the user of the wearable electronic device in the second input image;
determine that an amount of change between the first head pointing direction and the second head pointing direction exceeds a threshold value; and
determine, in response to the amount of change between the first head pointing direction and the second head pointing exceeding the threshold value, a second UI element on the display for selection based, at least in part, on the determined second head pointing direction.
